(19) United States
(12) Patent Application Publication
(10) Pub. No.: US 2010/0135719 A1
(43) Pub. Date: Jun. 3, 2010

(54) THREE-CLAMP LOCKING DEVICE

(76) Inventors: Lianping Liu, Changzhou (CN); Kaifeng He, Changzhou (CN)

Correspondence Address: CHRISTIE, PARKER & HALE, LLP, PO BOX 7068, PASADENA, CA, 91109-7068, US

(21) Appl. No.: 12/646,797

(22) Filed: Dec. 23, 2009

Related U.S. Application Data
(63) Continuation-in-part of application No. PCT/CN2008/000277, filed on Feb. 2, 2008.

(30) Foreign Application Priority Data
Jun. 26, 2006 (CN) 200710024653.3

(51) Int. Cl. F16B 21/00

(52) U.S. Cl. 403/326

(57) ABSTRACT

A three-clamp locking device comprising a locking housing, a three-clamp spring plate and an eccentric wheel, wherein the three-clamp spring plate is arranged within the locking housing and an opening in adaptation to the eccentric wheel is arranged at the three-clamp spring plate, wherein the three-clamp spring plate is configured to move forwards and backwards by means of rotation of the eccentric wheel provided in the opening, and a bulge for supporting, which supports the three-clamp spring plate, is arranged at the locking housing, and wherein the eccentric wheel is a fan-shaped eccentric wheel, and the opening is a semi-circular opening, which is adapted to the fan-shaped eccentric wheel and which is formed by overlapping a rectangular and a round shape.

### CROSS-REFERENCE TO RELATED APPLICATION

This application is a Continuation-In-Part of International Patent Application Number PCT/CN2008/000277, filed on Feb. 2, 2008, which claims priority of Chinese Patent Application Number 200710024653.3, filed on Jun. 26, 2006, the entire contents of both of which are incorporated herein by reference.

### BACKGROUND

1. Technical Field

The present invention relates to a locking device for rapidly connecting sections and including a rabbet (also referred to as a rebate), and more particularly, to a three-clamp locking device, which is composed of a three-clamp spring plate.

2. Related Art

Presently available three-clamp locking devices encompass a locking housing, a three-clamp spring plate and an eccentric wheel. The locking housing is an integral construction comprising an inner cavity. A convex lug in positional adaptation to the rabbet of section and a bulge for guiding the spring plate are arranged at the front part of the locking housing. A mounting hole for the eccentric wheel and a bulge for supporting the spring plates are arranged at the rear part of the locking housing. Two chamfers with unequal width, which are provided in a symmetrical manner at the front part of the three-clamp spring plate, divide the spring plate into three parts. The two edges are curved upwards by 180° to form forward stand bars. A downwards curvature by 180° takes place in the center with the formation of a backward stand bar. A small stand bar, which slants downwards, is at the center part of the spring plate, while the rear part of the spring plate is a circular opening in adaptation to the eccentric wheel.

A screw wrench opening is arranged at the upper part of the eccentric wheel. The upper cylinder section and the lower cylinder section are concentric and are adapted to (and/or configured for) the locking housing. The center part is the eccentric wheel in adaptation to the circular openings of the three-clamp spring plate and at an eccentric distance to the upper cylinder section and lower cylinder section. The spring plate moves forwards and backwards under the action of eccentric wheel. The section is furthermore fastened by the bulge (or by the means of the bulge) for guiding, which is provided at the locking housing. In Patent EP0166794 (the entire content of which is incorporated herein by reference), the eccentric wheel fulfills the functions of driving the spring plate to move forwards and backwards and preventing the eccentric wheel from rotating beyond 180°. These two functions are in each case realized by the eccentric wheel and the stopping bulge. In the case of a rotation of the eccentric wheel by 180° in clockwise direction, the eccentric wheel drives the spring plate to move backwards. The stopping bulge now leans tightly against the side face of the opening of the eccentric wheel of the three-clamp spring plate so as to prevent the rotation of the eccentric wheel by more than 180°. This construction encompasses the deficiencies specified below:
a. The production of the spring plate is complicated. The rear end of the spring plate is curved upwards by 90°, so that the locking dimensions of forward and backward stand bars cannot be ensured easily.
b. The production of the eccentric wheel is complicated. In order to ensure the movement distance of the spring plate, the dimensions of the eccentric wheel are too large, and an opening must be cut at the locking housing so as to keep off the eccentric wheel, which lowers the strength of the locking housing.
c. Due to the limitation of the dimensions of the construction, the stopping bulge cannot be too large and thus the stopping lever of force is relatively small. In response to a moment of the force of the locking being too high, the locking housing can tear easily, thus leading to a malfunction (or invalidation) of the lock.

Chinese Patent ZL98226976.5 (the entire content of which is incorporated herein by reference) also discloses a three-clamp locking device. The eccentric part of the eccentric wheel is a conventional circular construction. The eccentric wheel drives the spring plate to move forwards and backwards and prevents the rotation of the eccentric wheel by more than 180°. These two functional characteristics are both realized by a round eccentric wheel. In the case of a rotation of the eccentric wheel in clockwise direction, the eccentric wheel together with the long round opening of the spring plate move the spring plate backwards. In response to a rotation by 180°, the eccentric wheel leans tightly against the side face of the long round opening of the three-clamp spring plate and prevents the rotation of the eccentric wheel by more than 180°. The deficiencies of the afore-identified construction are specified below:
a. Due to the fact that the eccentric part of the eccentric wheel is a conventional round construction, only a small stopping lever of force, which only corresponds to the eccentric moment of force, is available during locking. A rotation of the eccentric wheel by more than 180° leads to the generated lateral force to increase in multiples and easily leads to crack of the locking housing and to an invalidation of the lock.
b. In response to a rotation by more than 180° when the eccentric being loosed, the self-locking angle is small, thus easily resulting in self-locking, so that the eccentric wheel cannot be pushed downwards, which negatively impacts the mounting and demounting of the three-clamp locking device.

### SUMMARY

An embodiment of the present invention provides a three-clamp locking device, which encompasses a locking housing, a three-clamp spring plate and an eccentric wheel, wherein the three-clamp spring plate is arranged within the locking housing, and an opening in adaptation to (and/or configured for) the eccentric wheel is arranged at the three-clamp spring plate, wherein the three-clamp spring plate is moved forwards and backwards by means of rotation of the eccentric wheel provided in the opening and a bulge for supporting the three-clamp spring plate is arranged at the locking housing. The eccentric wheel is a fan-shaped eccentric wheel, and the opening is a semi-circular opening, which is configured for the fan-shaped eccentric wheel and which is formed by overlapping a rectangular and a round shape.

The inner end face of the bulge for supporting is embodied as an inclined face and runs (and/or extends) upwards in a beveled manner to the extension direction of the three-clamp spring plate.

In the case of the improved three-clamp locking device, the side face of the fan-shaped eccentric wheel leans tightly against the straight edge of the other rectangular end of the semi-circular opening of the three-clamp spring plate in response to the rotation of the eccentric wheel in clockwise direction by 180°, which results in the locking of the section. The stopping lever of force is now greater than in the case of similar conventional locking devices including a round eccentric wheel and an eccentric wheel comprising a stopping bulge. This leads to an effective increase of the resistance against lateral stopping moments of force and to a reduction of possible malfunctions (or invalidations) of the product.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an illustration of a construction of a three-clamp locking device according to an embodiment of the present invention.

FIG. 2 is an illustration of a construction of a housing of the three-clamp locking device according to an embodiment of the present invention.

FIG. 3 is a top view of FIG. 2.

FIG. 4 is an illustration of a construction of a spring plate of the three-clamp locking device according to an embodiment of the present invention.

FIG. 5 is a top view of FIG. 4.

FIG. 6 is an illustration of a construction of an eccentric wheel of the three-clamp locking device according to an embodiment of the present invention.

FIG. 7 is an illustration of a state of use of the three-clamp locking device according to an embodiment of the present invention.

### EXPLANATION OF THE REFERENCE NUMERALS

| | |
|---|---|
| 1. locking housing | 2. three-clamp spring plate |
| 3. fan-shaped eccentric wheel | 4. convex lug |
| 5. bulge for guiding the spring plate | 6. mounting hole |
| 7. bulge for supporting the spring plate | 8. slot |
| 9. forward stand bar | 10. backward stand bar |
| 11. small stand bar | 12. semi-circular opening |
| 13. screw wrench opening | 14. upper cylinder section |
| 15. lower cylinder section | 16. fan-shaped eccentric wheel |

### DETAILED DESCRIPTION OF EMBODIMENTS

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Like reference numerals designate like elements throughout the specification.

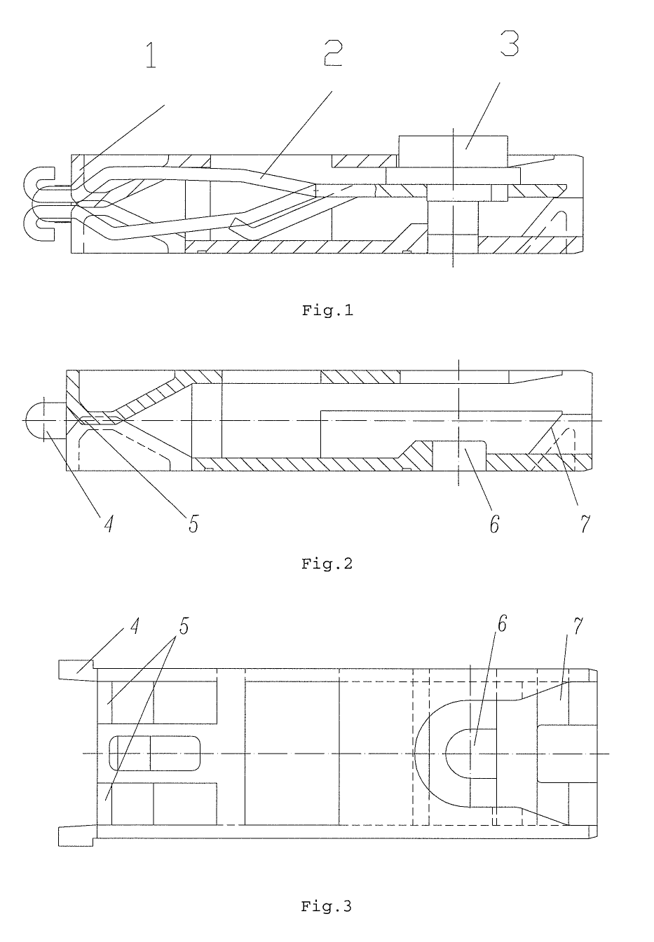

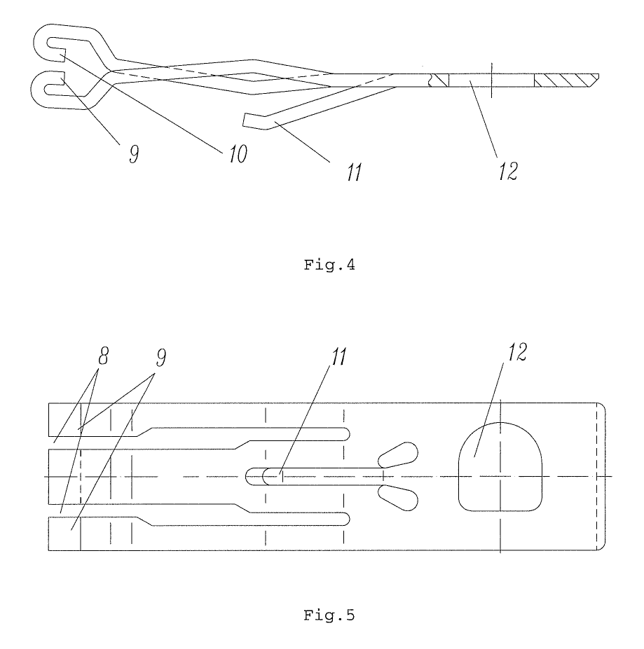

A detailed explanation of the present invention is to be illustrated below with reference to the figures. As is shown in FIG. 1, the three-clamp locking device is composed of a locking housing 1, a three-clamp spring plate 2 and a fan-shaped eccentric wheel 3, wherein the locking housing 1 is an integral construction having an inner cavity. A convex lug 4 (in positional adaptation to a rabbet of section) and a bulge 5 for guiding a spring plate are arranged at the front part of the locking housing 1. A mounting hole 6 for the eccentric wheel 3 and a bulge 7 for supporting a spring plate with an inclined face are arranged at the rear part of the locking housing 1. See FIG. 2 and FIG. 3 with reference thereto. Two chamfers 8 with unequal width, which are provided in a symmetrical manner at the front part of the three-clamp spring plate 2, divide the spring plate 7 into three parts. The two edges are curved upwards by 180° to form a forward stand bar 9. A downwards curvature by 180° takes place in the center with the formation of a backward stand bar 10. A small stand bar 11, which slants downwards, is arranged at the center part of the spring plate 2, while the rear part of the spring plate 2 is a semi-circular opening 12 in adaptation to the eccentric wheel 3, which is formed by overlapping a rectangular and round shape. See FIG. 4 and FIG. 5 with reference thereto.

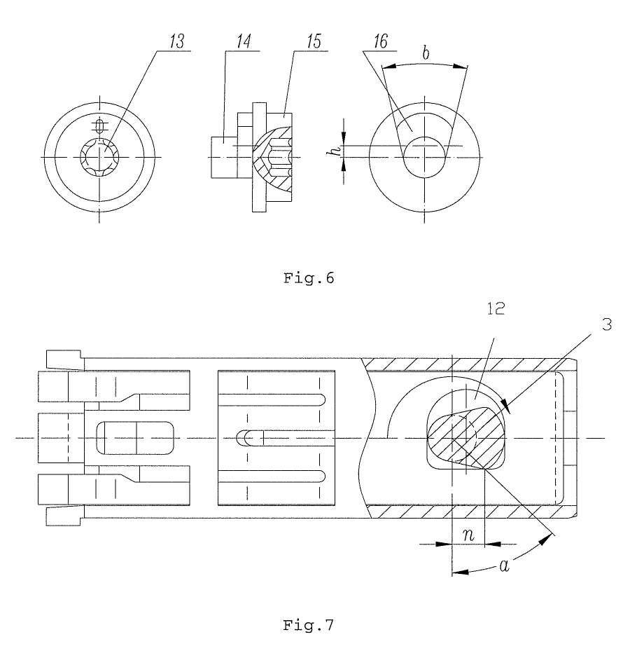

A screw wrench opening 13 is arranged at the upper part of the eccentric wheel 3. An upper cylinder section 14 and a lower cylinder section 15 are concentric and are adapted to the locking housing 1. The center part is a fan-shaped eccentric wheel 16 with eccentric distance h in adaptation to the semi-circular opening 12 of the three-clamp spring plate 2. The chord length corresponding to the arc of the fan-shaped eccentric wheel 16 can be less than the diameter of the upper cylinder section 14 or can also be more than the diameter of the upper cylinder section 14. Optimally, the angle b, which is formed by the tangents from both end points of the arc to the upper cylinder section 14, is no more than 120°. See FIG. 6 with reference thereto.

In response to the practical use, the eccentric wheel 3 is initially pushed downwards until it is flush with the locking housing 1 and is then inserted along the vertical direction into the section which has an opening for the eccentric wheel 3. The elastic force of the small stand bar 11 of the spring plate 2 causes the eccentric wheel 3 to spring out of the section opening, as shown in FIG. 7. The section provided with the locking device is inserted into the lateral rabbet of the section to be connected. The eccentric wheel 3 is rotated in clockwise direction by a screw wrench. The fan-shaped eccentric wheel 3 is adapted to the semi-circular opening 12 of the spring plate 2 and drives the three-clamp spring plate 2 to move backwards. In response to the rotation of the eccentric wheel 3 up to 180°, the side face of the fan-shaped eccentric wheel 3 leans tightly against the straight edge of the semi-circular opening 12 of the three-clamp spring plate 2 so as to prevent the rotation of the eccentric wheel 3 by more than 180° with invalidation of the locking. At the same time, the bulge 5 for guiding, which is provided at the locking housing 1, causes the forward stand bar 9 and the backward stand bar 10 of the spring plate to be opened and to hook the inner side faces of the rabbet of the section, thus the two sections are locked together. In this case, the rear end of the spring plate 2 is located above the bulge 7 for supporting, which is provided at the locking housing 1, and prevents the eccentric wheel from moving downwards, as shown in FIG. 5.

In response to the rotation of the eccentric wheel in clockwise direction by 180° which results in the locking of the section, the side face of the fan-shaped eccentric wheel 3 leans tightly against the straight edge of the semi-circular opening 12 of the three-clamp spring plate 2. See FIG. 5 with reference thereto. In this case, the stopping lever of force n is greater than in the case of similar conventional locking devices comprising a round eccentric wheel and an eccentric wheel comprising a stopping bulge. This thus leads to an effective increase of the resistance against lateral moments of force. The increased lever of force thus simultaneously leads to an increase of the self-locking angle a, thus self-locking does not take place when the eccentric wheel is loosened and rotated beyond 180°, so that the eccentric wheel can be pushed downwards. Mounting and demounting of the three-clamp locking device are thus facilitated.

### Contents of the Invention According to an Embodiment

The technical problem, which is to be solved by an embodiment of the present invention, lies in overcoming the aforementioned deficiencies of the prior art by providing a three-clamp locking device with large stopping lever of force in response to locking, so as to prevent crack of the locking housing and an invalidation of the lock caused by an increased lateral force.

To solve the aforementioned technical problems, an embodiment of the present invention provides the following technical solutions:

A three-clamp locking device, which encompasses a locking housing, a three-clamp spring plate and an eccentric wheel, wherein the three-clamp spring plate is arranged within the locking housing and an opening in adaptation to the eccentric wheel is arranged at the three-clamp spring plate, wherein the three-clamp spring plate is moved forwards and backwards by means of rotation of the eccentric wheel provided in the opening. Furthermore, a bulge for supporting the three-clamp spring plate is arranged at the locking housing. The eccentric wheel is a fan-shaped eccentric wheel and the opening is a semi-circular opening, which is adapted to the fan-shaped eccentric wheel and which is formed by overlapping a rectangular and a round shape.

The inner end face of the bulge for supporting is embodied as an inclined face and runs upwards in a beveled manner to the extension direction of the three-clamp spring plate.

As compared to the prior art, an embodiment of the present invention encompasses the following advantages:
1. In the case of the improved three-clamp locking device, the side face of the fan-shaped eccentric wheel leans tightly against the straight edge of the other rectangular end of the semi-circular opening of the three-clamp spring plate in response to the rotation of the eccentric wheel in clockwise direction by 180° and in response to locking of the section. The stopping lever of force is now greater than in the case of similar conventional locking devices comprising a round eccentric wheel and in the case of an eccentric wheel comprising a stopping bulge. This thus leads to an effective increase of the resistance against lateral moments of force. The increased stopping lever of force thus simultaneously leads to an increase of the self-locking angle, so that a self-locking does not take place when the eccentric wheel is loosened and rotated beyond 180°, thus the eccentric wheel cannot be pushed downwards. Mounting and demounting of the three-clamp locking device are thus facilitated.
2. After the bulge for supporting and guiding the spring plate, which is at the rear end of the locking housing, changes from straight edge to bevel edge, in the event of a downwards movement of the spring plate, for example due to an incorrect operation, the spring plate can be restored along the bevel edge and the reliability of the operation is thus ensured. The strength of the locking housing is thus increased at the same time.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A three-clamp locking device comprising a locking housing (1), a three-clamp spring plate (2) and an eccentric wheel (3), wherein the three-clamp spring plate (2) is arranged within the locking housing (1) and an opening (4) in adaptation to the eccentric wheel (3) is arranged at the three-clamp spring plate (2), wherein the three-clamp spring plate (2) is configured to move forwards and backwards by means of rotation of the eccentric wheel (3) provided in the opening (12), and a bulge (7) for supporting, which supports the three-clamp spring plate (2), is arranged at the locking housing (1), and wherein the eccentric wheel is a fan-shaped eccentric wheel (3), and the opening (12) is a semi-circular opening, which is adapted to the fan-shaped eccentric wheel (3) and which is formed by overlapping a rectangular and a round shape.

2. The three-clamp locking device according to claim 1, wherein the inner end face of the bulge (7) for supporting is embodied as an inclined face and that it extends upwards in a beveled manner to the extension direction of the three-clamp spring plate.

3. A three-clamp locking device comprising a locking housing (1), a three-clamp spring plate (2) and an eccentric wheel (3), wherein the three-clamp spring plate (2) is arranged within the locking housing (1) and an opening (4) in adaptation to the eccentric wheel (3) is arranged at the three-clamp spring plate (2), wherein the three-clamp spring plate (2) is configured to move forwards and backwards by rotation of the eccentric wheel (3) provided in the opening (12), and a bulge (7) for supporting, which supports the three-clamp spring plate (2), is arranged at the locking housing (1), and wherein the eccentric wheel is a fan-shaped eccentric wheel (3), and the opening (12) is a semi-circular opening, which is adapted to the fan-shaped eccentric wheel (3) and which is formed by overlapping a rectangular and a round shape.
